(19) United States
(12) Patent Application Publication
(10) Pub. No.: US 2024/0211681 A1
(43) Pub. Date: Jun. 27, 2024

(54) GENERATING ELECTRONIC DOCUMENTS FROM VIDEO

(71) Applicant: Microsoft Technology Licensing, LLC, Redmond, WA (US)

(72) Inventors: Huitian JIAO, Snoqualmie, WA (US); Max WANG, Seattle, WA (US); Tomasz Lukasz RELIGA, Seattle, WA (US)

(21) Appl. No.: 18/145,933

(22) Filed: Dec. 23, 2022

(51) Int. Cl. G06F 40/166; G06F 40/279; G06V 20/40; G10L 15/26; G10L 25/57

(52) U.S. Cl. CPC G06F 40/166; G06F 40/279; G06V 20/41; G06V 20/49; G10L 15/26; G10L 25/57

(57) ABSTRACT

A computing apparatus comprising one or more computer readable storage media, one or more processors operatively coupled with the one or more computer readable storage media, and an application comprising program instructions stored on the one or more computer readable storage media that direct the computing apparatus to at least generate a transcript for a video and identify keyframes in the video based on the transcript. The keyframes are segmented into presentation frames and regular frames. For at least a presentation frame of the presentation frames, a topic represented in the presentation frame is identified, and for at least a regular frame of the regular frames, a topic represented in a portion of the transcript corresponding in time to the regular frame is identified. The keyframes are organized into topic groups based on the topic identified for each of the keyframes, and an electronic document is generated based on the topic groups.

### TECHNICAL FIELD

Aspects of the disclosure are related to the field of computer software applications and services and, in particular, to technology for generating documents based on video content.

### BACKGROUND

An ever-increasing amount of video content presents a challenge to those interested in consuming information contained therein. For example, as online meetings have exploded in popularity, participants often record the meetings and distribute the recordings for others to consume at a later time. Other types of video content include recordings of live presentations, video tutorials, and the like. However, consuming such video content is time consuming, inconvenient at times, and for some users with certain disabilities, difficult to consume at all.

Solutions to these problems have arisen in the form of services that automatically convert video presentations to an electronic document format such as a slide presentation or portable document format (.PDF) file. The solutions produce transcripts of spoken content in a video as well as screen shots of a presentation. Problematically, the screen shots are poorly organized such that they split the transcript at ineffective points such as midway through a sentence. In addition, a full transcript takes a good deal of time to navigate and consume, and thus does little to mitigate the larger problems discussed above.

### OVERVIEW

Technology disclosed herein includes a service that generates electronic documents from recorded video, thereby improving access to audio-visual content and reducing wasteful computation overhead. In an implementation, a software application on a computing device directs the device to generate a transcript for a video, identify keyframes in the video based on the transcript, and segment the keyframes into presentation frames and regular frames. For at least a presentation frame of the presentation frames, the software application further directs the device to identify a topic represented in the presentation frame, and for at least a regular frame of the regular frames, the software application directs the device to identify a topic represented in a portion of the transcript corresponding in time to the regular frame. The software application then directs the device to organize the keyframes into topic groups based on the topic identified for each of the keyframes and generate an electronic document based on the topic groups.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates an operational environment in an implementation.

FIG. 2 illustrates a document generation process in an implementation.

FIG. 3 illustrates an operational scenario in an implementation.

FIG. 4 illustrates an operational architecture in an implementation.

FIG. 5 illustrates an operational scenario in an implementation.

FIG. 6 illustrates an operational scenario in an implementation.

FIG. 7 illustrates an operational scenario in an implementation.

FIG. 8 illustrates a computing system suitable for implementing the various operational environments, architectures, processes, scenarios, and sequences discussed below with respect to the other Figures.

### DETAILED DESCRIPTION

Technology disclosed herein is generally directed to generating documents based on video content. The document generation technology disclosed herein improves access to recorded content while also reducing computational overhead as compared to existing technological solutions. Various implementations described herein employ a document generation process on one or more computing devices that facilitates automatic or semi-automatic conversion of video content into an electronic document. The document generation process may be employed locally with respect to a user experience (e.g., on a user's device), remotely with respect to the user experience (e.g., on a server), or distributed between or amongst multiple devices.

In various implementations, such computing devices include one or more processors operatively coupled with one or more computer readable storage media. Program instructions stored on the one or more computer readable storage media that when executed by the one or more processors, direct a given computing device to carry out various steps with respect to a representative document generation process. For example, a suitable computing device generates a transcript for a video and identifies keyframes in the video based on the transcript. The computing device then segments the keyframes into presentation frames and regular frames. For the presentation frames, the computing device identifies a topic represented in the presentation frame. For the regular frames, the computing device identifies a topic represented in a portion of the transcript corresponding in time to the regular frame. The computing device then organizes the keyframes into topic groups based on the topic identified for each of the keyframes, and generates an electronic document based on the topic groups.

Various technical effects that result from the generation of an electronic document based on video content as disclosed herein may be apparent. In one example, identifying topics in different ways for different types of keyframes results improved topic generation because the topics are not drawn solely from transcript materials, but also from information represented in presentation frames. For instance, a symbol or other such element represented in a presentation frame may be absent from the transcript (or absent from a portion of the transcript corresponding to the presentation frame. Thus, drawing topics from the presentation frames increases the likelihood that a relevant topic will not be overlooked in the resulting summary document. Moreover, the richer the set of topics discovered in the keyframes, the better the grouping of keyframes, and ultimately the richer the sections of an electronic document produced from the video. More broadly, the technology disclosed herein reduces the time required of users to consume the information presented in videos. Such time savings have a concrete manifestation in the ability of users to be more efficient and more productive.

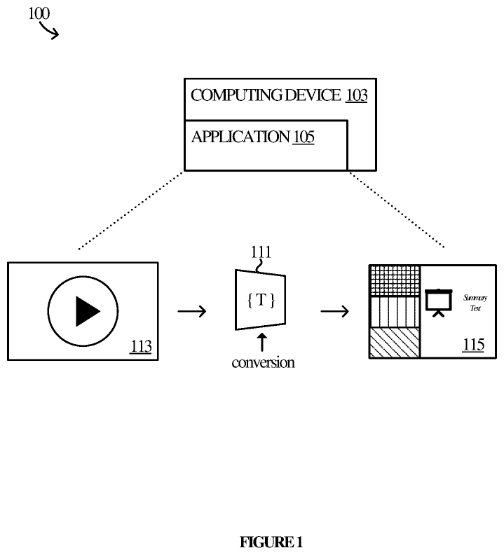

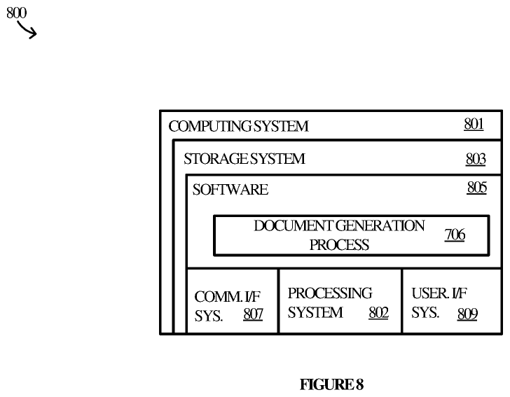

Turning to the figures, FIG. 1 illustrates an operational environment 100 in an implementation. Operational environment 100 includes computing device 103, media file 113, and document 115. Examples of computing device 103 include personal computers, server computers, tablet computers, mobile phones, or any combination or variation thereof, and any other suitable devices, of which computing device 801 in FIG. 8 is broadly representative.

Computing device 103 includes one or more software applications, of which application 105 is representative. Application 105 may be a natively installed and executed application, a browser-based application, a mobile application, or any other application suitable for converting a video (e.g., media file 113) into a document (e.g., electronic document 115). Application 105 may execute in a stand-alone manner (e.g., as in the case of a natively installed application) or within the context of another application (e.g., as in the case of a plug-in or browser-based application), or in some other manner. Media file 113 includes audio data that represents sounds encoded in accordance with an audio coding format, as well as image data that represents images encoded in accordance with a video coding format. Document 115 is representative of an electronic document such as a slide presentation document, a word processing document, digital notebooks), or any other suitable electronic document.

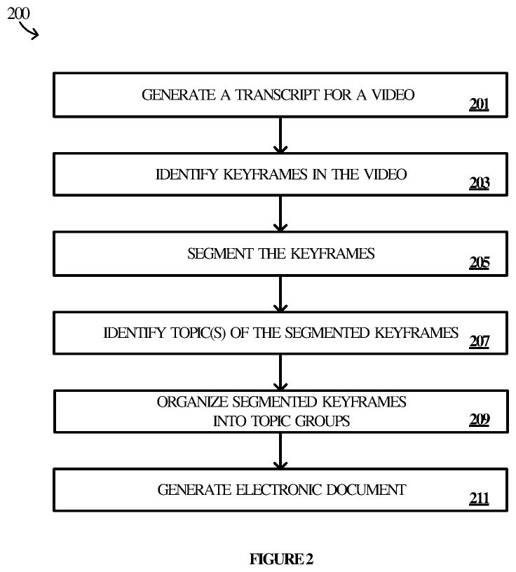

Application 105 includes one or more components, represented by transformation engine 111, capable of transforming a media file into an electronic document. Transformation engine 111 implements a document generation process 200 illustrated in more detail in FIG. 2. Document generation process 200 may be implemented in program instructions in the context of any software application, module, component, service, micro-service or other such elements of one or more computing devices. The program instructions direct the one or more computing devices to operate as follows, referring to a computing device in the singular for the sake of clarity.

In operation, a computing device employing document generation process 200 generates a transcript for a video (step 201). The transcript may include timestamps that match the transcribed speech to the audio data stream. The computing device then identifies keyframes of the video based on the transcribed speech (step 203). For example, the computing device may examine the transcript to determine (e.g., from a timestamp) when a sentence begins, and may further select a frame from the video at a time corresponding to the beginning of the sentence. Alternatively, the computing device may examine the transcript to determine when a sentence ends and may select a frame from the video at a time corresponding to the end of the sentence or select a frame from the video at any other time corresponding to a portion of the sentence. In other words, the keyframes may be identified based on the timing of a transcribed sentence within the context of the video stream.

Additionally, the computing device may identify keyframes in the video by examining image data of the video to determine clarity, content, context, relevance, etc. of individual frames, and select keyframes that meet and/or exceed a keyframe threshold. A keyframe threshold may be objective (e.g., based on an average value as obtain over a plurality of frames of a video) or subjective (e.g., comprise a specific target value, comprise a range of values, comprise a value derived at independent of the content of the frames of a video, etc.). A keyframe threshold may have different values for different frame characteristics. In other words, characteristics such as clarity, content, context, relevance, etc., may have keyframe thresholds unique to the specific characteristic.

Next, the computing device segments the keyframes into presentation frames and regular frames (step 205). For example, the computing device may examine the keyframes to identify a presence of textual content, a presence of a slide presentation in the background or foreground, a presence of a chart in the background or foreground, and the like. Based on the identified features, the computing device then classifies a keyframe as belonging to either the presentation frames or the regular frames.

Then, the computing device identifies one or more topics of the segmented keyframes (step 207). When analyzing at least a presentation frame of the presentation frames, the computing device identifies a topic represented in the presentation frame (e.g., based on the image data of the video file). Alternatively, when analyzing at least a regular frame of the regular frames, the computing device identifies a topic represented in a portion of the transcript corresponding in time to the regular frame (e.g., based on a timestamp of the transcript).

The computing device organizes the segmented keyframes into topic groups (step 209). For example, the computing device may group keyframes according to the topic identified for each of the keyframes. This may result in the mixing of keyframe types. For example, some of the regular frames may have a topic in-common with some of the presentation frames. As such, some of the groups may include regular keyframes as well as presentation frames.

Finally, the computing device (subject to document generation process 200) generates an electronic document that corresponds to the topic groups (step 211). For instance, the computing device may generate content (e.g., an interactive chart that represents a chart of the video, summary of the transcript, slides of a slide presentation, images, etc.) and organizes the generated content according to the identified topics. For example, a slide presentation document generated by the computing device may have a slide for each topic, and the slides may be organized according to the sequence and/or timing of the keyframes in the video. Similarly, the computing device may generate electronic images of text or text and graphics and organize the electronic images according to the sequence and/or timing of the keyframes in the video. Alternatively, the computing device may organize the generated content according to an importance value where content having a higher importance value appear in the document prior to an appearance of the content having a lesser importance value. Importance values may be assessed according to an amount of time a topic is presented in a video, a sequence of topics in a video, a presenter of a topic, etc.

Referring back to FIG. 1, the following describes an application of document generation process 200 with respect to the elements of operational environment 100. In operation, application 105 employs transformation engine 111 to direct computing device 103 to generate a transcript for video 113 and identify keyframes in the video based on the transcript. Application 105 then directs computing device 103 to segment the keyframes into presentation frames and regular frames. For each of the presentation frames, application 105 directs computing device 103 to identify one or more topics represented in the image data of the presentation frames. For each of the regular frames, application 105 directs computing device 103 to identify one or more topics represented in the portion of the transcript that corresponds in time to the regular frames. Application 105 then directs computing device 103 to organize the segmented keyframes into topic groups and generate document 115 based at least on the topic groups.

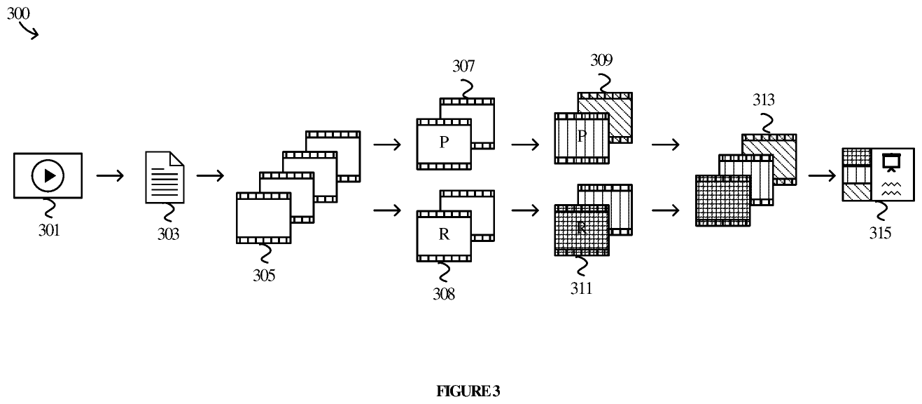

FIG. 3 illustrates operational scenario 300 in an implementation. To begin, video 301 is analyzed by a computing device to identify the audio and image data of video 301. The computing device generates transcript 303 based on the audio data of video 301 and identifies keyframes 305 of the image data based on transcript 303.

Keyframes 305 are segmented by the computing device into presentation frames 307 and regular frames 308. Presentation frames 307 and regular frames 308 are then analyzed by the computing device to identify topics. As represented by p-frames 309, two topics were identified for presentation frames 307: a first topic depicted by the vertical pattern and a second topic depicted by the diagonal pattern. As represented by r-frames 311, two topics were identified for regular frames 308: the first topic depicted by the vertical pattern and a third topic depicted by the square pattern.

Then, p-frames 309 and r-frames 311 are organized by the computing device into topic frames 313. Specifically, the computing device generates topic frames 313 by merging p-frames 309 with r-frames 311 and segmenting the merged keyframes according to topic (e.g., 2 keyframes segmented together for the first topic, 1 frame segmented to the second topic, and 1 frame segmented to the third topic). The computing device may then rank the merged keyframes. For example, the first topic of the present embodiment has two keyframes (a p-frame and an r-frame), and the computing device may rank the p-frame higher than the r-frame, or vice versa. Alternatively, the computing device may rank the first topic higher than the second topic because it occurs first in the video runtime, or the third topic may be ranked higher than the first topic because the third topic has a longer total runtime than the first topic, or the computing device may rank the keyframes based on some other metrics.

After ranking the merged keyframes, the computing device may filter out or otherwise select keyframes of the merged frames for inclusion in the generated document. For example, though two keyframes were originally identified for topic one, the computing device of the present embodiment organized the four merged frames into the three frames of topic frames 313 by selecting only one keyframe to represent the first topic. Though the current embodiment depicts topic frames 313 as comprising one keyframe for each topic, it is contemplated herein that more than one keyframe may be selected to represent a given topic. The computing device then generates electronic document 315 based on topic frames 313.

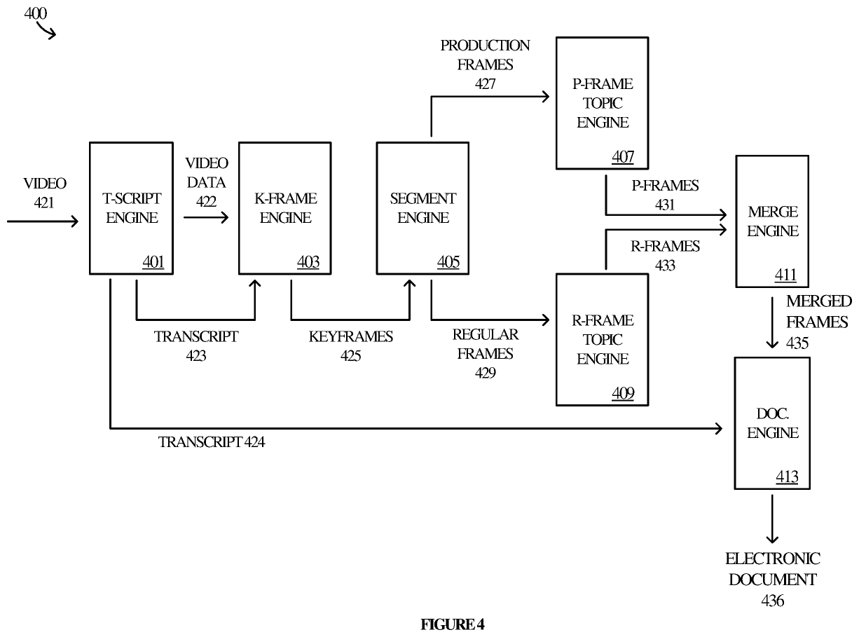

FIG. 4 illustrates an operational architecture 400 that may be employed in an implementation for providing the document generation capabilities disclosed herein. Operational architecture 400 includes transcript engine 401, keyframe engine 403, segment engine 405, p-frame topic engine 407, r-frame topic engine 409, merge engine 411, and document engine 413.

Transcript engine 401 is representative of any component(s) capable of receiving video and/or other media file and producing a transcript. Keyframe engine 403 is representative of any component(s) capable of receiving transcript and image data and producing keyframes. Segment engine 405 is representative of any component(s) capable of receiving keyframes and producing presentation frames and regular frames. P-frame topic engine 407 is representative of any component(s) capable of receiving presentation frames and producing p-frames. R-frame topic engine 409 is representative of any component(s) capable of receiving regular frames and producing r-frames. Merge engine 411 is representative of any component(s) capable of receiving p-frames and r-frames and producing merged frames. Document engine 413 is representative of any component(s) capable of receiving transcripts and/or merged frames and producing electronic documents.

In another embodiment, transcript engine 401 is representative of any component(s) capable of receiving video and/or other media file and a producing transcript feature vector. Keyframe engine 403 is representative of a machine learning model capable of receiving a transcript feature vector and image data and producing a keyframe feature vector. Segment engine 405 is representative of a machine learning model capable of receiving a keyframe feature vector and producing a presentation frame feature vector and a regular frame feature vector. P-frame topic engine 407 is representative of a machine learning model capable of receiving production a frame feature vector and producing a p-frame feature vector. R-frame topic engine 409 is representative of a machine learning model capable of receiving a regular frame feature vector and producing a r-frame feature vector. Merge engine 411 is representative of a machine learning model capable of receiving a p-frame feature vector and an r-frame feature vector and producing a merged frame feature vector. Document engine 413 is representative of a machine learning model capable of receiving a transcript feature vector and/or a merged frame feature vector and producing an electronic document.

In operation, transcript engine 401 receives video 421 and generates transcript 423 and/or transcript 424. Transcript engine 401 may generate transcripts 423 and 424 using a speech to text model, sentence tokenizer, sentence punctuation model, and the like. Transcript 423 may include a full transcript of video 421 divided into a series of transcript lines, timestamps, numbered sentences, etc. Transcript 424 may include a full or partial transcript of video 421, a summary of the transcript of video 421, timestamps, numbered sentences, etc. Transcript engine 401 then transmits transcript 423 to keyframes 425 and/or transmits transcript 424 to document engine 413.

Keyframe engine 403 may receive transcript 423 and image data 422 from transcript engine 401 and generate keyframes 425. For example, keyframe engine 403 may identify keyframes in the image data of video 421 based on the lines and/or sentences of transcript 423 (e.g., one frame per line of text, a frame at the beginning of the sentence, a frame at the end of the sentence, etc.) and may then select a sequence of the identified frames to generate keyframes 425. Though keyframe engine 403 is depicted at receiving image data 422 from transcript engine 401, it is contemplated herein that keyframe engine 403 may receive image data 422 from a source other than transcript engine 401. Keyframe engine 403 then transmits keyframes 425 to segment engine 405.

Alternatively, keyframe engine 403 may use a machine learning model (ML Model) to generate keyframes 425. For example, keyframe engine 403 may employ the ML Model to extract keyframes from vectorized image data for association with transcript 423. The ML Model may use image understanding to select frames most relevant to a topic, frames that are clearest (e.g., free of artifacts, etc.), frames that contain presentation content (e.g., charts, slide presentations, data boxes, presentational information, etc.), and the like. Keyframe engine 403 may then use the selected frames to generate keyframes 425.

Segment engine 405 receives keyframes 425 from keyframe engine 403 and generates presentation frames 427 and regular frames 429. Segment engine 405 may segment keyframes 425 into presentation frames and regular frames by employing one or more of an optical character recognition application to extract text from image data of a keyframe, a heuristics-based algorithm to detect background information in image data of a keyframe, and edge or line detection application to identify charts or other graphical content in the image data of a keyframe. Segment engine 405 determines which frames contain at least a threshold amount of presentation content (e.g., textual content that explains a concept, a presence of a slide presentation in the background or foreground, a presence of a chart, the inclusion and subsequent exclusion of presentation information, etc.) to classify keyframes 425 into productions frames and regular frames. The threshold amount of presentation content may be objective (e.g., based on an average presence of presentation content across a plurality of frames of a video) or subjective (e.g., comprise a specific target value, comprise a range of values, comprise a value derived at independent of the content of the frames of a video, comprise a value of >20%, etc.).

Segment engine 405 generates presentation frames 427 and regular frames 429 from the segmented keyframes and transmits presentation frames 427 to p-frame topic engine 407 and regular frames 429 to r-frame topic engine 409. Alternatively, segment engine 405 may use an ML Model to generate presentation frames 427 and regular frames 429. For example, segment engine 405 may employ the ML Model to classify and segment vectorized keyframe data based on extracted features of the vectorized keyframe data. Extracted features may facilitate the classification of a keyframe as a presentation frame or regular frame based on a determination that the extracted feature indicates a presence of at least a threshold amount of presentation content. Segmentation engine 405 may generate an image of an extracted feature and perform an all-vs-all similarity match to keyframes 425 to determine a classification for each frame of keyframes 425.

P-frame topic engine 407 receives presentation frames 427 from segment engine 405 and produces p-frames 431 based on one or more topics identified for presentation frames 427. P-frame topic engine 407 may identify a topic represented in a presentation frame by recognizing the topic in image data extracted from a presentation frame, by comparing content of adjacent keyframes of presentation frames 427 to detect content included in one frame and excluded from another frame, detecting scene transitions (e.g., when a threshold amount of change is detected or exceeded), etc. Examples of a threshold amount of change include removal of all or a defined portion of presentation content, addition of a defined portion of presentation content, etc.

Alternatively, p-frame topic engine 407 may use a ML Model to generate p-frames 431. For example, p-frame topic engine 407 may employ the ML Model to leverage existing video recordings to identify scenes and scene transitions that occur in presentation frames 427 and/or recognize a topic in image data extracted from the presentation frames 427.

P-frame topic engine 407 then forms a topic group by grouping together the keyframes of presentation frames 427 identified as having the same or similar topic. Keyframes that overlap in content (e.g., are close in appearance) may be removed or otherwise filtered out of the topic group. P-frame topic engine 407 then generates p-frames 431 comprising the topic groups and transmits p-frames 431 to merge engine 411.

R-frame topic engine 409 receives regular frames 429 from segment engine 405 and produces r-frames 433 based on one or more topics identified for regular frames 429. For example, r-frame topic engine 409 may use a text segmentation model to split transcript 423 into coherent topics and identify a topic represented in a regular frame of regular frames 429 by recognizing the topic in a portion of transcript 423 corresponding to the regular frame. In an embodiment, r-frame topic engine 409 may split transcript 423 into coherent topics by employing a ML Model that clusters text representations built from word vectors generated by a neural network based on transcript 423. Boundaries of the topics represented in regular frames of regular frames 429 may also be identified (e.g., based on times noted by timestamps of transcript 423, based on a numerical order of the text representation of each cluster according to transcript 423, etc.), and the regular frames of regular frames 429 located between the identified boundaries may be grouped together to form a topic group.

R-frame topic engine 409 then generates r-frames 433 comprising the topic groups and transmits r-frames 433 to merge engine 411. Merge engine 411 receive p-frames 431 and r-frames 433 and produces merged frames 435. Merge engine 411 may produce merged frames 435 by regrouping p-frames 431 with r-frames 433 into a collection. The collection may be organized based on the topics identified for p-frames 431 or r-frames 433. For example, organizing based on the topics identified for p-frames 431 entails identifying a runtime for a topic of p-frames 431 and merging the p-frames with the r-frames corresponding to the runtime. Organizing based on the topics identified for r-frames 433 entails identifying a boundary for a topic of r-frames 433 and merging the r-frames with the p-frames corresponding to the boundary.

If after merging, merged frames 435 exceeds a threshold value of keyframes, merge engine 411 may further organize the keyframes by ranking them and filtering out keyframes that have a lower ranking as compared to adjacent keyframes. For example, p-frames 431 may be ranked higher than r-frames 433 resulting in an r-frame being filtered out of the merged frames in favor of a p-frame, and vice versa. Alternatively, a keyframe closest to a boundary of a topic may be ranked higher than a keyframe further from a topic value resulting in the removal of the further keyframe in favor of the closed keyframe, and vice versa. The threshold value of keyframes may be determined based on a target number of slides to be generated by document engine 413, a target number of pages for electronic document 436, or the like. When the number of keyframes is less than or equal to the threshold value of keyframes, merge engine 411 generates merged frames 435 based on the organized keyframes and transmits merged frames 435 to document engine 413.

Document engine 413 receives transcripts 424 and/or merged frames 435 and produces electronic document 436. For example, document engine 413 may leverage a presentation application to generate electronic document 436 having sections corresponding to topic groups of the merged frames. Each section may include an image derived from the keyframe selected for the corresponding topic as well as all, a portion, or a summary of transcript 424. Text, graphics, and/or links of electronic document 436 may be selectable to open video 421 at a runtime corresponding to a timestamp of transcript 423, to expand a summary of the transcript into a more detailed summary, to open a full version of transcript 424, etc. Alternatively, document engine 413 may leverage a search engine to access external content corresponding to a topic of merged frames 435 and generate elements (e.g., charts, images, text, etc.) of electronic document 436 based on the external content.

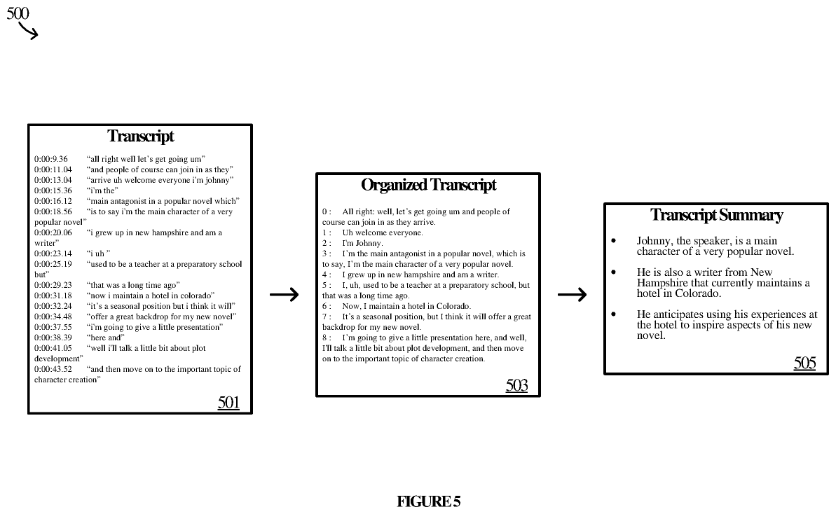

FIG. 5 illustrates a brief operational scenario 500 in which transcript 501 is generated by a computing device (not shown) based on a video recording (not shown). Transcript 501 includes timestamps corresponding to a runtime of the video recording and a series of lines of text generated based on audio data of the video recording. Organized transcript 503 is a tokenized version of transcript 501. Specifically, the computing device generates organized transcript 503 by removing the timestamps of transcript 501, adding punctuation to the sentences of transcript 501, adding a numeric value to the sentences, and organizing the sentences according to their numeric value. Summary 505 is a summary of the topics identified by a computing device for transcript 501 or organized transcript 503, or both.

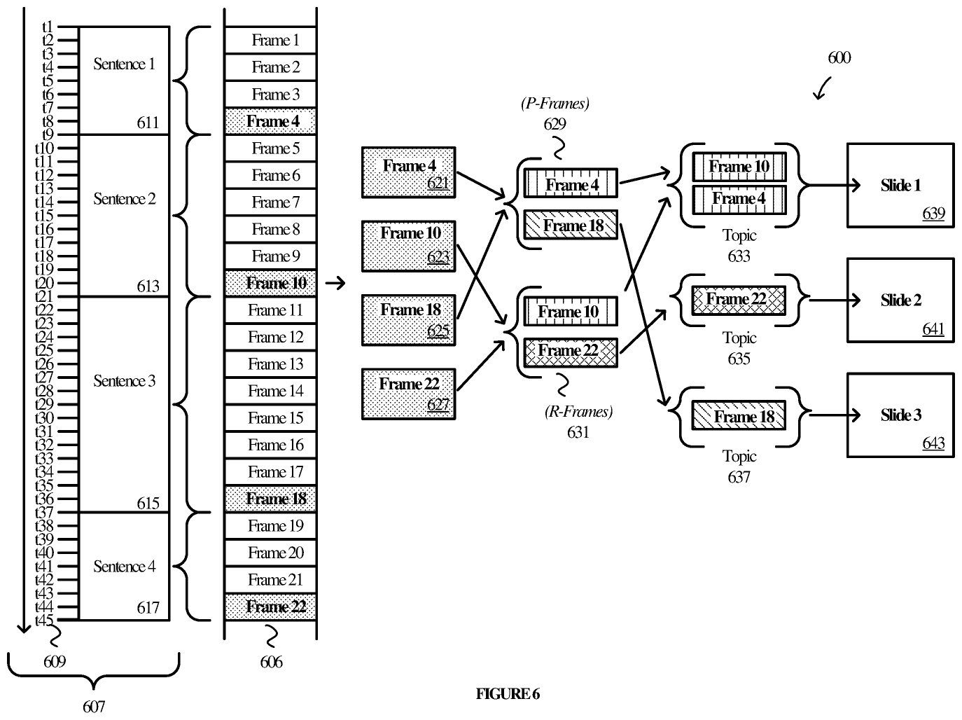

FIG. 6 illustrates a brief operational scenario 600 in which a computing device (not shown) generates slides 601-605 based on the content of video recording 606. Specifically, the computing device generates transcript 607 from audio data of a video recording 606. Transcript 607 includes timestamps 609 and sentences 611-617. Based on transcript 607, the computing device identifies keyframes 621-627 in the image data of video recording 606. In the present embodiment, keyframes are identified based on transitions between sentences in transcript 607 and a runtime of video recording 606 corresponding to the transitions. For example, Frame 4 of video recording 606 is identified as keyframe 621 because Frame 4 is located at a runtime that corresponds to the timestamps noted at the end of sentence 611 (i.e., t7-t9), and Frame 10 of video recording 606 is identified as keyframe 623 because Frame 10 is located at a runtime that corresponds to the timestamps noted at the end of sentence 613 (i.e., t19-t21). Similarly, Frame 18 of video recording 606 is identified as keyframe 625 because Frame 18 is located at a runtime that corresponds to the timestamps noted at the end of sentence 615 (i.e., t35-t37), and Frame 22 of video recording 606 is identified as keyframe 627 because Frame 22 is located at a runtime that corresponds to the timestamps noted at the end of sentence 617 (i.e., t43-t45). Though the present embodiment selects a frame of video recording 606 that corresponds in time to an end of a sentence of transcript 607, it is contemplated herein that any frame of video recording 606 may be identified as a keyframe so long as the frame corresponds in time to some portion of a sentence of transcript 607.

Next, the computing device segments the keyframes into presentation frames 629 and regular frames 631. Specifically, keyframes 621 and 625 are segmented together as presentation frames 629, and keyframes 623 and 627 are segmented together as regular frames 631. Then, the computing device identifies topics for presentation frames 629 and regular frames 631. For example, for presentation frames 629, the computing device analyzes video content of the presentation frames to identify their respective topics, and for regular frames 631, the computing device identifies topics by analyzing the portion of transcript 607 that corresponds in time to the frames of regular frames 631.

After identifying the topics of presentation frames 629 and regular frames 631, the computing device organizes presentation frames 629 and regular frames 631 into topic groups 633-637 based on a similarity of the topic identified for each of presentation frames 629 and regular frames 631 relative to each other. For example, the computing device merges Frame 4 of the presentation frames with frame 10 of the regular frames to form topic group 633 because the two keyframes were identified as having the same and/or similar topic (as represented by the vertical hashing). Topic group 635 includes a regular frame having a topic represented by a cross hashing, which differs from topic groups 633 and 637, and topic group 637 includes a presentation frame having a topic represented by a diagonal hashing, which differs from topic groups 633 and 635.

The computing device may further organize presentation frames 629 and regular frames 631 by ranking and filtering them. For example, Frame 10 of topic group 633 is ranked higher than Frame 4. Additionally, the topic groups may be ranked (e.g., based on topic content, runtime of topic compared to other topics, etc.).

Finally, the computing device generates slide 639 based on topic group 633, slide 641 based on topic group 635, and topic 643 based on topic group 637. The slide may contain text from transcript 607, a summary derived from transcript 607, charts generated to reflect image data of keyframes, images and text obtain via search engines, and the like. The slides may then be incorporated into a final slide presentation generated by the computing device.

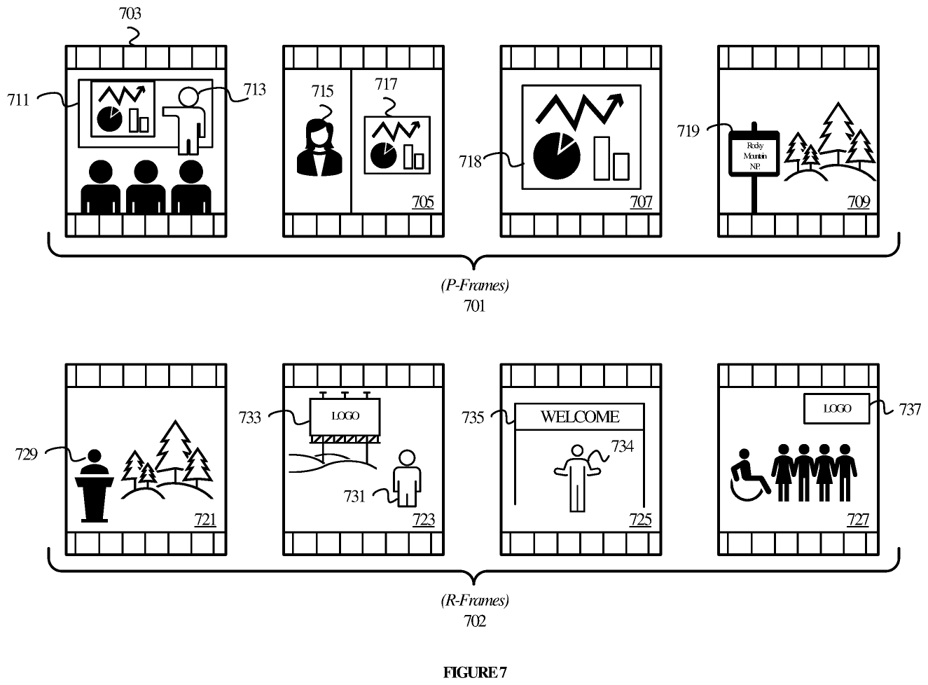

FIG. 7 illustrates a brief operational scenario 700 in which several examples of presentation frames (e.g., p-frames 701) and regular frames (e.g., r-frames 702) are provided. P-frames 701 include keyframes 703-709, and r-frames 702 include keyframes 721-727.

In an embodiment, a computing device may identify a keyframe as a presentation frame based on a presence of presentation content (e.g., charts, slide presentations, data boxes, visual information used to elaborate upon a topic and/or concept, etc.). For example, keyframe 703 includes presentation content 711 and presenter 713, keyframe 705 includes a split screen with presenter 715 on the left side of the split and presentation content 717 on the right side of the split, keyframe 707 includes only presentation content 718, and keyframe 709 includes presentation content 719.

In another embodiment, a computing device may identify a keyframe as a regular frame based at least on an absence of presentation content. For example, keyframe 721 includes speaker 729 in the foreground of the frame and a scenic background, keyframe 723 includes speaker 731 in the foreground of the frame and billboard 733 in the background, keyframe 725 includes speaker 734 in the foreground and signpost 735 in the background, and keyframe 727 includes logo 737 in the foreground and a group of speakers in the background.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, mobile phones, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements document generation process 806, which is representative of the document generation processes discussed with respect to the preceding Figures, such as document generation process 200. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including document generation process 806) may be implemented in program instructions and among other functions may, when executed by processing system 802, direct processing system 802 to operate as described with respect to the various operational scenarios, sequences, and processes illustrated herein. For example, software 805 may include program instructions for implementing a document generation process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support document generation features, functionality, and user experiences. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
an application comprising program instructions stored on the one or more computer readable storage media that, when executed by the one or more processors, direct the computing apparatus to at least:
generate a transcript for a video;
identify keyframes in the video based on the transcript;
segment the keyframes into presentation frames and regular frames;
for at least a presentation frame of the presentation frames, identify a topic represented in the presentation frame;
for at least a regular frame of the regular frames, identify a topic represented in a portion of the transcript corresponding in time to the regular frame;
organize the keyframes into topic groups based on the topic identified for each of the keyframes; and
generate an electronic document based on the topic groups.

2. The computing apparatus of claim 1 wherein the keyframes comprise frames of the video corresponding in time to transitions between sentences in the transcript, and wherein the program instructions further direct the computing apparatus to:
identify the sentences in the transcript; and
identify the frames in the video corresponding in time to the transitions between the sentences in the transcript.

3. The computing apparatus of claim 2 wherein to organize the keyframes into the topic groups, the program instructions direct the computing apparatus to rank, filter, and merge the keyframes based on a similarity of the topic identified for each of the presentation frames relative to the topic identified for each other of the presentation frames.

4. The computing apparatus of claim 3 wherein to segment the keyframes into the presentation frames and the regular frames, the program instructions direct the computing apparatus to classify each keyframe of the keyframes as belonging to one of the presentation frames or the regular frames based on whether the keyframe includes a threshold amount of presentation content.

5. The computing apparatus of claim 3 wherein to identify the topic represented in the presentation frame, the program instructions direct the computing apparatus to recognize the topic in image data extracted from the presentation frame.

6. The computing apparatus of claim 5 wherein to identify the topic represented in the regular frame, the program instructions direct the computing apparatus to recognize the topic in a portion of the transcript corresponding to the regular frame.

7. The computing apparatus of claim 1 wherein the electronic document comprises a slide presentation having sections corresponding to the topic groups.

8. A method comprising:
generating a transcript for a video;
identifying keyframes in the video based on the transcript;
segmenting the keyframes into presentation frames and regular frames;
for at least a presentation frame of the presentation frames, identifying a topic represented in the presentation frame;
for at least a regular frame of the regular frames, identifying a topic represented in a portion of the transcript corresponding in time to the regular frame;
organizing the keyframes into topic groups based on the topic identified for each of the keyframes; and
generating an electronic document based on the topic groups.

9. The method of claim 8 wherein the keyframes comprise frames of the video corresponding in time to transitions between sentences in the transcript, and wherein the method further comprises:
identifying the sentences in the transcript; and
identifying the frames in the video corresponding in time to the transitions between the sentences in the transcript.

10. The method of claim 9 wherein organizing the keyframes into the topic groups comprises ranking, filtering, and merging the keyframes based on a similarity of the topic identified for each of the presentation frames relative to the topic identified for each other of the presentation frames.

11. The method of claim 10 wherein segmenting the keyframes into the presentation frames and the regular frames comprises classifying each keyframe of the keyframes as belonging to one of the presentation frames or the regular frames based on whether the keyframe includes a threshold amount of presentation content.

12. The method of claim 10 wherein identifying the topic represented in the presentation frame comprises recognizing the topic in image data extracted from the presentation frame.

13. The method of claim 12 wherein identifying the topic represented in the regular frame comprises recognizing the topic in a portion of the transcript corresponding to the regular frame.

14. The method of claim 8 wherein the electronic document comprises a slide presentation having sections corresponding to the topic groups.

15. One or more computer readable storage media having program instructions stored thereon that, when executed by one or more processors, direct a computing apparatus to at least:
generate a transcript for a video;
identify keyframes in the video based on the transcript;
segment the keyframes into presentation frames and regular frames;
for at least a presentation frame of the presentation frames, identify a topic represented in the presentation frame;
for at least a regular frame of the regular frames, identify a topic represented in a portion of the transcript corresponding in time to the regular frame;
organize the keyframes into topic groups based on the topic identified for each of the keyframes; and
generate an electronic document based on the topic groups.

16. The one or more computer readable storage media of claim 15 wherein the keyframes comprise frames of the video corresponding in time to transitions between sentences in the transcript, and wherein the program instructions further direct the computing apparatus to:
identify the sentences in the transcript; and
identify the frames in the video corresponding in time to the transitions between the sentences in the transcript.

17. The one or more computer readable storage media of claim 16 wherein to organize the keyframes into the topic groups based on the topic identified for each of the presentation frames and the regular frames, the program instructions direct the computing apparatus to rank, filter, and merge the keyframes based on a similarity of the topic identified for each of the presentation frames relative to the topic identified for each other of the presentation frames.

18. The one or more computer readable storage media of claim 17 wherein to segment the keyframes into the presentation frames and the regular frames, the program instructions direct the computing apparatus to classify each keyframe of the keyframes as belonging to one of the presentation frames or the regular frames based on whether the keyframe includes a threshold amount of presentation content.

19. The one or more computer readable storage media of claim 17 wherein to identify the topic represented in the presentation frame, the program instructions direct the computing apparatus to recognize the topic in image data extracted from the presentation frame.

20. The one or more computer readable storage media of claim 19 wherein to identify the topic represented in the regular frame, the program instructions direct the computing apparatus to recognize the topic in a portion of the transcript corresponding to the regular frame.
